(19) United States
(12) Patent Application Publication
(10) Pub. No.: US 2006/0066064 A1
(43) Pub. Date: Mar. 30, 2006

(54) Mobile paint caddy

(76) Inventor: Randy J. Hardy, Flemington, NJ (US)

Correspondence Address: Kenneth P. Glynn, Esq.;Glynn & Associates, P.C., 24 Mine Street, Flemington, NJ, 08822, US

(21) Appl. No.: 10/955,852

(22) Filed: Sep. 30, 2004

(51) Int. Cl. B62B 1/00

(52) U.S. Cl. 280/79.2

(57) ABSTRACT

The mobile paint caddy includes a main cabinet, one or more push handles, wheels, and at least two diverse insertable, interchangeable trays. The main cabinet has an access door or doors located thereon and has at least one storage compartment. The main cabinet top has a cut out and a support frame adapted to receive the insertable, interchangeable trays. One tray is for use with a paint supply for a roller, and the other for use with a paint supply from a can or pot. The trays have a central area section and an outer peripheral section, with a foot print sufficient to rest upon the support frame of the main cabinet.

### BACKGROUND OF THE INVENTION

1. Field of the Invention

The present invention relates to a device for assisting both home improvement painters and professional painters. More particularly, it is directed to a multitask enabling, mobile paint caddy that provides for mobility, storage, paint supply, roller pan and paint can usage, as well as brush cleaning and storing. Thus, the present invention caddy has provisions for most interior painters' needs, and may accommodate exterior painters as well.

2. Information Disclosure Statement

The following patents exemplify the state of the art for painters' supply carts:

U.S. Pat. No. 5,509,672 describes a painter's supply cart having a sink formed therein. The sink has a fuseable link heat door hingedly secured to an edge thereof. The cart has four caster wheels disposed on corners thereof. The cart has a first compartment and a second compartment. The first compartment has a plurality of shelves disposed therein. The second compartment has a removable container-disposed therein positioned beneath the sink. The cart has a pair of doors hingedly secured on opposing edges thereof. An upper support board is secured to the cart and extends upwardly above the cart. The upper support board has a front surface and a rear surface. The front surface has a plurality of securement hooks secured thereto. The front surface has a paper towel holder secured thereon. A brake mechanism is secured to a bottom end of the cart.

U.S. Pat. No. 6,695,325 B2 describes a multipurpose paint caddy which comprises: a frame; a T-handle for moving and manipulating the frame; containment structure for positioning a paint bucket on the top side of the frame and for storing paint apparatus in juxtaposition with the paint bucket; and a wheel arrangement for facilitating rolling and tilting movement of the frame whereby to obviate obstacles encountered during movement of the frame on the ground. In a preferred wheel arrangement, two pairs of swivelable small diameter wheels extends below each end portion of the frame, and two pairs of non-swivelable large diameter wheels extends below the central portion of the frame. The handle and one pair of large diameter wheels enables the user to transmit a pivoting force to one end of the frame, whereupon the small diameter wheels adjacent thereto are driven into engagement with the ground and the large diameter wheels at the other frame end lifted.

Notwithstanding the prior art, the present invention is neither taught nor rendered obvious thereby.

### SUMMARY OF THE INVENTION

The present invention mobile paint caddy includes a main cabinet, one or more push handles, wheels, and at least two diverse insertable, interchangeable trays.

The main cabinet may have any shape, but linear shapes are most convenient for maximizing production, storage and parking the devices, both in marketing and in use by the end consumer. The main cabinet has at least a sidewall, a bottom and an at least partially open top. The bottom is preferably closed as is/are the sidewall(s). (In the cases of a barrel-like, cylindrical, truncated conical or elliptical cabinet, there is a single side wall; triangular-three side walls. Thus, “side wall” should be taken to mean singular and plural walls as used herein.) The mobile paint caddy main cabinet is primarily constructed of materials selected from the group consisting of wood, plastic, metal and combinations thereof.

The main cabinet has an access door or doors located thereon and has a storage compartment located therein. The main cabinet top has a support frame adapted to receive the insertable, interchangeable trays. Typically, the top is cut out, and the remaining peripheral acts, at least in part, as the support frame for the trays. The access door(s) may be on the front, side or sides, the back or a combination thereof. In some embodiments, the access door is located on one side. Also, in some preferred embodiments, the doors are sealable, as with a sealing flange or rim, such as a foam or rubber trim. This keeps the odor of stored paint and supplies contained, and reduces undesirable evaporation of wet or soaking brushes.

There is at least one push handle connected to the main cabinet. This could be built into the cabinet, directly affixed to the cabinet or extended outwardly therefrom. While one handle is sufficient, for some preferred embodiments, handles at opposing ends may be advantageous.

There is a plurality of wheels located at the bottom of the main cabinet to render the main cabinet mobile. Two wheels will be adequate, e.g., at the opposite end of a handle, but four wheels are desired. The wheels must at least roll on the floor, that is be rotatable about a horizontal axis. However, wheels that roll and swivel, and hence rotate about a horizontal axis and about a vertical axis, are preferred.

A critical feature of the present invention device is two or more diverse trays, one for use with a paint supply for a roller, and the other for use with a paint supply from a can or pot. Thus, the invention includes at least two insertable, interchangeable trays, each of the trays having a central area section and an outer peripheral section, the outer peripheral section having a foot print sufficient to rest upon the support frame of the main cabinet, wherein the first tray has a bottom located at the central area section that is adapted to receive either a paint roller tray, or a paint roller tray insert where the first tray eliminates the need for a roller tray, and wherein the second tray has at least one orifice located at the central area section that is adapted to receive and hold a paint container having a circular top view. “Circular” should be taken to mean a generally circular shape, like a paint can, or truncated conical shape, like a disposable cardboard or plastic paint pot (pail). These may also have preferred sealing edges or meet with sealing edges at the support frame, to close off the storage area of the cabinet. Alternatively, the cabinet could have an inside ceiling below the level where the trays would be located in their inserted positions.

In some preferred embodiments of the present invention device, the first tray has a tapered bottom located at the central area section that is adapted to function as a paint roller tray and as a paint tray plastic insert holder.

In some preferred embodiments of the present invention mobile paint caddy, the main cabinet has a top view selected from the group consisting of circular, oval, rectangular, square and trapezoidal.

In some preferred embodiments of the present invention mobile paint caddy, the main cabinet has a front wall, two side walls and a back wall and the access door is located on one of the front wall, two side walls and a back wall.

In some preferred embodiments of the present invention, the access door includes a securing latch that secures the access door to the main cabinet to render the main cabinet air tight when the access door is latched.

In some preferred embodiments of the present invention, the access door securing latch includes a locking mechanism.

In some preferred embodiments of the present invention, the main cabinet further includes at least one brush hanger.

In some embodiments, the top of the cabinet and/or at least one of the two insertable, interchangeable trays includes a cut-out for storing at least one paintbrush. The cut-out may include a recessed structure and a cover. (the term “cut out” means orifice that may be created or formed by means other than being cut out, and still be within the scope of the meaning of the word as intended herein.

In some preferred embodiments, the insertable tray itself may be a mini-caddy with wheels. In other words, one of the paint can trays, for example, could be boxed out to be rectangular and level with wheels added, so that the boxed out areas and the wheels still clear the cabinet opening and do not interfere with insertion or removal of the tray from the cabinet.

### BRIEF DESCRIPTION OF THE DRAWINGS

The present invention should be more fully understood when the specification herein is taken in conjunction with the drawings appended hereto wherein:

FIG. 1 shows an oblique front view of one embodiment of a present invention mobile paint caddy, and

FIG. 2 shows a top view thereof;

FIGS. 3 and 4 illustrate a side and a top view, respectively, of one insertable tray used in some present invention preferred mobile paint caddies;

FIG. 5 shows a side view of another tray used in the present invention that may be substituted for the tray shown in FIGS. 3 and 4 above;

FIGS. 6 and 7 illustrate a side and a top view, respectively, of another insertable tray used in some present invention preferred mobile paint caddies, for holding paint cans and the like and may be used in conjunction with and interchangeable with the tray of FIGS. 3 and 4 and/or the tray of FIG. 5;

FIG. 8 shows a front view of one embodiment of a present invention mobile paint caddy that is different from that described above, and has two separate storage compartments with separate access doors; and,

FIG. 9 shows an oblique side view of a modified present invention device tray with wheels to function as a mini-caddy.

### DETAILED DESCRIPTION OF THE PRESENT INVENTION

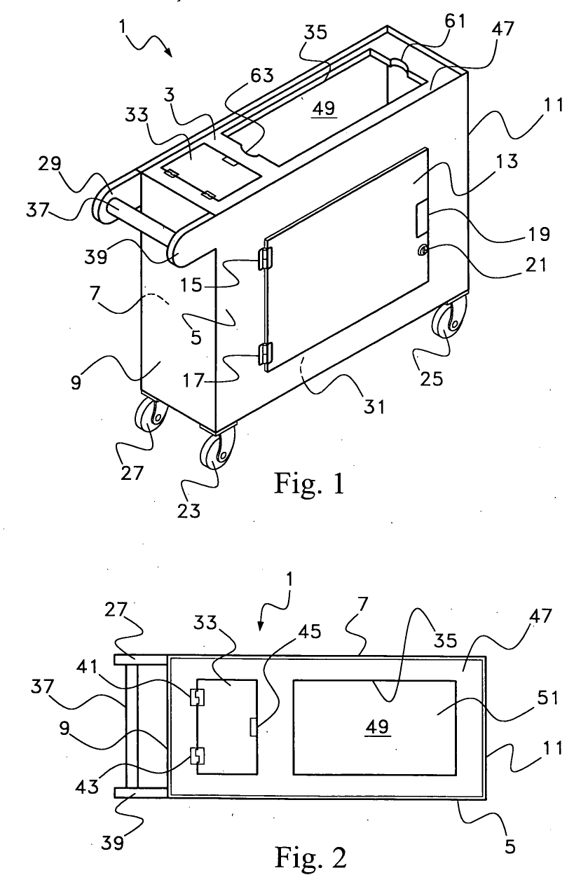

FIG. 1 shows present invention mobile paint caddy 1, and FIG. 2 shows a top view thereof. Both Figures are now discussed collectively. Caddy 1 includes a cabinet that comprises top 3, a right side wall 5, a left side wall 7, a back 9, a front 11 and a bottom 31. This may be made of any structure or combination of materials, and a practical, inexpensive version may be constructed of wood and metal fasteners and hinges. Other embodiments could be metal or plastic or combinations thereof, similar to plastic and metal tool chests.

The side walls 5 and 7, as well as the bottom 31, back 9 and front 11 are all solid, i.e., are closed or essentially airtight. This is not necessary, but is necessary for those embodiments wherein the objective of a closed storage space is desired. Top 3 has a cut out 35 to create an opening 49. The opening 49 and the remaining frame 47 are adapted to receive interchangeable trays, described further with the Figures below. Underneath the top 3 may be empty space, opening directly into the main storage area below, or a separation wall or ceiling may be fitted between the main storage area and the open top 3.

Access door 13 has hinges 15 and 17, latch 19 and lock 21. It also has a thin rubber sealing pad 57 to make it close substantially airtight. FIG. 2 shows top 3 and ceiling panel 51 below opening 49, with sufficient clearage for the trays to be inserted and rest upon frame 47. There is an auxiliary compartment under door 33. This is attached via hinges 41 and 43 and has latch 45

Handle 37 is connected via extensions 29 and 39 at back 9 and top 3, as shown. Swivel wheels 23, 25, 27 and one front left (not shown) are connected to bottom 31 at the corners. These rotate in two planes to roll and swivel. Finger notches 61 and 63 are optional but afford more ease in removal of the interchangeable trays.

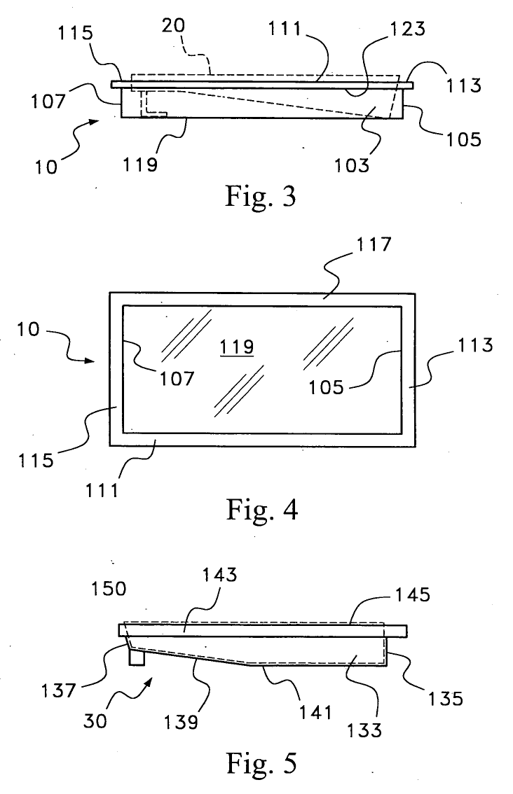

FIGS. 3 and 4 illustrate a side and a top view, respectively, of insertable tray 10, used in some present invention preferred mobile paint caddies, including caddy 1 shown in FIGS. 1 and 2 above. Tray 10 is adapted to receive paint tray 20, and includes sides, such as side 103, and front 107 and back 109. It is generally an open top box-like structure with a peripheral flange. This flange is a continuum and has a frame formed by side sections 111 and 117, and front section 113 and back section 115. The flange need not be completely encircling and could be separate flanges, like tabs. The flange is adapted to nest atop a support frame of a present invention caddy cabinet top, such as frame 47 of FIGS. 1 and 2. Optional sealing trim could be included on the underside 123 of the flange to render the cabinet more airtight in those embodiments wherein there is no ceiling panel below the cabinet top cut out.

FIG. 5 shows a side view of another tray 30 that may be used in the present invention caddy and that may be substituted for tray 10 shown in FIGS. 3 and 4 above. Tray 30 is not completely rectangular as is tray 10 of FIGS. 3 and 4. Here, tray 30 is not designed to receive a paint roller tray, but instead is designed to receive a disposable paint roller tray plastic insert. Hence, tray 30 has a partially tapered bottom to act as the roller tray itself and to conform to the shape of a standard paint tray insert 150. Tray 30 has an open top 145, a support flange mating outer peripheral 143, walls 133, 135, and 137 and another wall to the back of the Figure (not shown). Significantly, due to its function, it includes a flat bottom section 141, and a sloped or tapered bottom section 139.

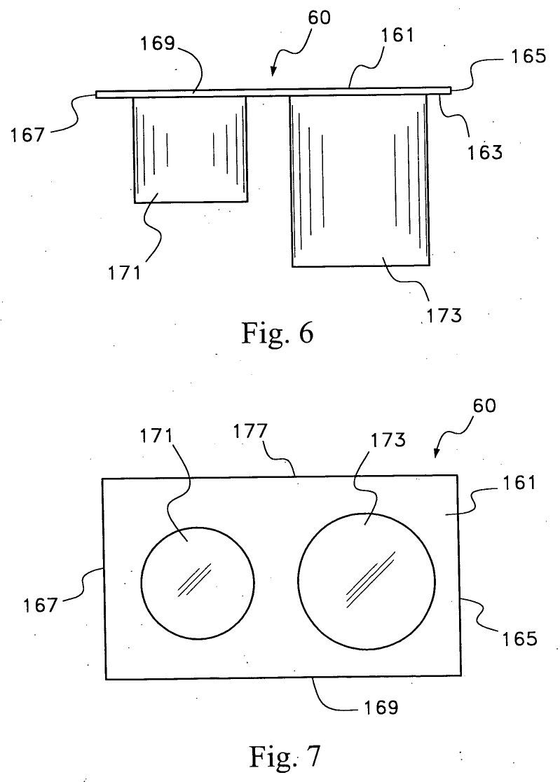

FIGS. 6 and 7 illustrate a side and a top view, respectively, of another insertable tray 60, that may be used in some present invention preferred mobile paint caddies, including those shown in the above and below Figures, and it is used for holding paint cans and the like. In some preferred embodiments, it may be used in conjunction with and interchangeable with tray 10 of FIGS. 3 and 4 and/or tray 30 of FIG. 5. Both Figures are discussed together. Tray 60 includes an open top 161, that includes a support frame outer peripheral area with front 165, sides 169 and 177, and back 167. There are two different size cut outs with open top, closed bottom hollow cylinders 171 and 173 that extend downwardly from the top 161. These cylinders 171 and 173 are sized to receive quart and gallon paint containers, but could be other sizes as well, e.g. metric paint can sizes. This tray 60, as well as any other trays contemplated by the present invention, may be made of any viable material, and wood, plastic and metal are preferred. Further, although the cylinder walls and bottom are shown as solid, they could be perforated, made of strips, woven like baskets, formed of wire or mesh, or otherwise formed, as long as they could support the paint cans intended to be placed therein.

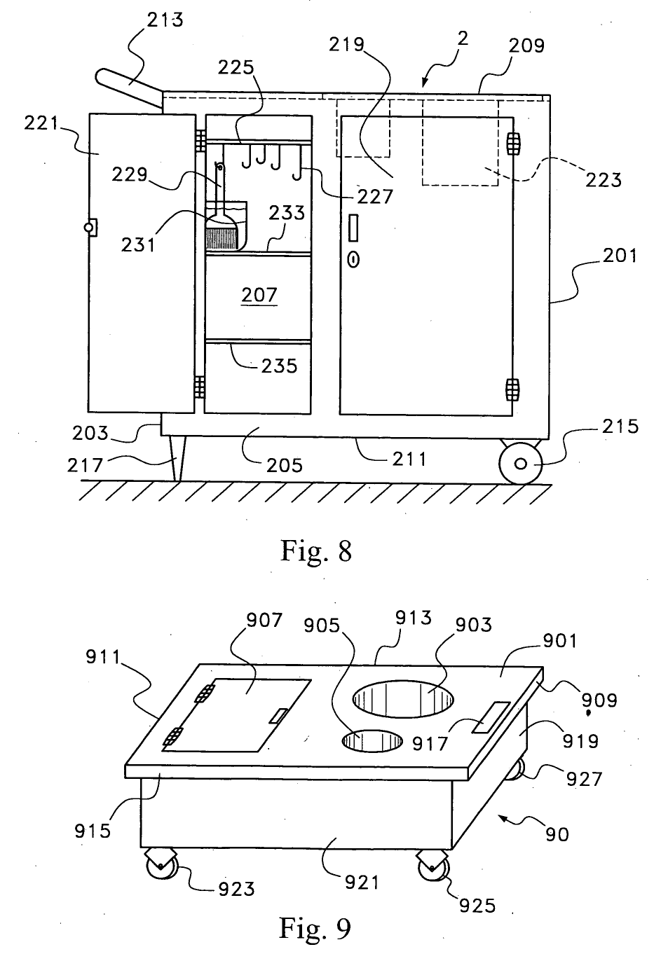

FIG. 8 shows a front view of one embodiment of a present invention mobile paint caddy 2 that is different from that described above, and has two separate storage compartments in the cabinet, with separate access doors. Here, the cabinet has a front 201, a back 203, a first side 205, and a second side that is solid (not shown). It also has an open top 209 and a closed bottom 211. Top 209 is similar to top 3 of FIGS. 1 and 2 above.

In this front view, it can be seen that caddy 2 includes a left and a right storage area and there may or may not be a vertical dividing wall between the two storage areas. There are front wheels, such as wheel 215, and back legs, such as leg 217. In this embodiment, a painter would lift handle 213 to lift the legs and move the caddy on the front wheels.

Doors 219 and 221 provide access to the two storage areas, and each has hinges and a latch, with optional locking, and optional sealing. The left storage area has a hanger rod 225, with various hooks 227 for hanging paint brushes, such as brush 229. Shelves 233 and 235 are provided, and rinse pot 231 is strategically positioned to soak brush 229. Other wet brushes could be wrapped and stored, and other paint supplies, paperwork, purchase orders, invoices, paint chips, cans, brushes, screwdrivers, mixing sticks, etc. could likewise be stored her. In the right storage area (behind access door 219), could be more storage shelves, or an open area for storage of paint cans of any size, drop cloths, etc. Note that a tray 223 is in place on the top 209 of caddy 2, and any tray contemplated could be inserted, as this tray is removable and interchangeable.

FIG. 9 shows an oblique side view of tray 90, with top 901. Top 901 includes front flange 909, back flange 911, side flanges 913 and 915. Pull handle 917 may be a cut-out, loop handle or any other pull mechanism. Top 901 includes gallon paint can hollow cylinder 903 and quart paint can hollow cylinder 905, in this embodiment, position side-by-side. Attached to the underside of tray top 901 is a boxed framework to create both an even, flat base for wheels and an additional storage area. This storage area may be accessed by door 907. Front 919 and 921 exemplify this boxed frame work and show dimensions smaller outer periphery of tray top 901 to create a ledge for nesting atop the support frame of a present invention caddy. Wheels such as wheels 923, 925 and 927 make tray 90 a mini-caddy that may be removed from its nesting caddy and easily pulled around for painting low areas such as base boards.

In addition to the trays described above, additional interchangeable trays could be included with the present invention caddies. For example, a tray having a custom configuration for nesting portable spray paint equipment, or for nesting spackle and repair (paint preparation) tools could be included. It is contemplated that an unused tray could be stored in the storage area(s) of the caddy cabinet.

Obviously, numerous modifications and variations of the present invention are possible in light of the above teachings. It is therefore understood that within the scope of the appended claims, the invention may be practiced otherwise than as specifically described herein.

What is claimed is:

1. A mobile paint caddy, which comprises:
(a) a main cabinet having at least a sidewall, a bottom and an at least partially open top, said main cabinet having an access door located thereon and having a storage compartment located therein, said main cabinet top having a support frame adapted to receive insertable, interchangeable trays;
(b) at least one push handle connected to said main cabinet;
(c) a plurality of wheels located at said bottom to render said main cabinet mobile;
(d) at least two insertable, interchangeable trays, each of said trays having a central area section and an outer peripheral section, said outer peripheral section having a foot print sufficient to rest upon said support frame of said main cabinet, wherein a first tray has a bottom located at said central area section that is adapted to receive a paint roller tray, and wherein a second tray has at least one orifice located at said central area section that is adapted to receive and hold a paint container having a circular top view.

2. The mobile paint caddy of claim 1 wherein said main cabinet has a top view selected from the group consisting of circular, oval, rectangular, square and trapezoidal.

3. The mobile paint caddy of claim 1 wherein said main cabinet has a front wall, two side walls and a back wall and said access door is located on one of said front wall, two side walls and a back wall.

4. The mobile paint caddy of claim 3 wherein said access door includes a securing latch that secures said access door to said main cabinet to render said main cabinet air tight when said access door is latched.

5. The mobile paint caddy of claim 4 wherein said access door securing latch includes a locking mechanism.

6. The mobile paint caddy of claim 1 wherein said plurality of wheels includes at least two wheels having means for rotation about a vertical axis and a horizontal axis.

7. The mobile paint caddy of claim 1 wherein said main cabinet is primarily constructed of materials selected from the group consisting of wood, plastic, metal and combinations thereof.

8. The mobile paint caddy of claim 1 wherein at least one of said trays includes wheels to create a mobile mini-caddy.

9. The mobile paint caddy of claim 1 wherein at least one of said two insertable, interchangeable trays includes a cut-out for storing at least one paintbrush.

10. The mobile paint caddy of claim 9 wherein said cut-out includes a recessed structure and a cover.

11. A mobile paint caddy, which comprises:
(a) a main cabinet having at least a sidewall, a bottom and an at least partially open top, said main cabinet having an access door located thereon and having a storage compartment located therein, said main cabinet top having a support frame adapted to receive insertable, interchangeable trays;
(b) at least one push handle connected to said main cabinet;
(c) a plurality of wheels located at said bottom to render said main cabinet mobile;
(d) at least two insertable interchangeable trays, each of said trays having a central area section and an outer peripheral section, said outer peripheral section having a foot print sufficient to rest upon said support frame of said main cabinet, wherein a first tray has a tapered bottom located at said central area section that is adapted to function as a paint roller tray and as a paint tray plastic insert holder, and wherein a second tray has at least one orifice located at said central area section that is adapted to receive and hold a paint container having a circular top view.

12. The mobile paint caddy of claim 11 wherein said main cabinet has a top view selected from the group consisting of circular, oval, rectangular, square and trapezoidal.

13. The mobile paint caddy of claim 11 wherein said main cabinet has a front wall, two side walls and a back wall and said access door is located on one of said front wall, two side walls and a back wall.

14. The mobile paint caddy of claim 13 wherein said access door includes a securing latch that secures said access door to said main cabinet to render said main cabinet air tight when said access door is latched.

15. The mobile paint caddy of claim 14 wherein said access door securing latch includes a locking mechanism.

16. The mobile paint caddy of claim 11 wherein said plurality of wheels includes at least two wheels having means for rotation about a vertical axis and a horizontal axis.

17. The mobile paint caddy of claim 11 wherein said main cabinet is primarily constructed of materials selected from the group consisting of wood, plastic, metal and combinations thereof.

18. The mobile paint caddy of claim 11 wherein at least one of said trays includes wheels to create a mobile mini-caddy.

19. The mobile paint caddy of claim 11 wherein at least one of said two insertable, interchangeable trays includes a cut-out for storing at least one paintbrush.

20. The mobile paint caddy of claim 19 wherein said cut-out includes a recessed structure and a cover.
